(19) United States
(12) Patent Application Publication
(10) Pub. No.: US 2005/0136952 A1
(43) Pub. Date: Jun. 23, 2005

(54) Wireless instant messaging and multi-media conferencing solution

(76) Inventors: Bohdan Zabawskyj, Woodbridge (CA); Shyam Sheth, Toronto (CA)

Correspondence Address: Bohdan Zabawskyj, 213 NOVAVIEW CRESCENT, WOODBRIDGE, ON, L4L 9C8, CA

(21) Appl. No.: 10/736,505

(22) Filed: Dec. 17, 2003

(51) Int. Cl. H04Q 7/20

(52) U.S. Cl. 455/466; 455/414.1; 455/426.1

(57) ABSTRACT

The invention disclosed provides for a real-time voice, text and multi-media messaging solution between mobile (and in some respects wireline) subscribers to support Push-To-Talk (PTOT) and Instant Messaging functionality through its combination of messaging server platforms (CPP2) and client-side applications (CPP1).

### CROSS-REFERENCE TO RELATED APPLICATIONS

Patent application Ser. No. 10/307335 entitled “Improved method for implementing an Open Charging (OC) middleware platform and gateway system”.

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND ART

Instant messaging technologies have been around for well over a decade, and with the new ‘wireless boom’, the migration of the technology to wireless platforms (handsets, PDAs, and the like) remained inevitable. For instance, U.S. patent application 20030014488 by Dalal et al., entitled system and method for enabling multimedia conferencing services on a real-time communications platform, outlines a system and method for enabling multimedia, real-time group communications on real-time communications platforms. Although, the art does not particularly embrace and/or remain directed at the wireless aspects thereof, including aspects relating to presence and location, and furthermore, nor does it intimate or suggest any of the push to talk (PTT) elements and/or functionality described in our application of present.

Other prior art may be gleaned from U.S. patent application 20030126213 by Betzler, entitled establishing direct instant messaging communication between wireless devices, provides techniques for establishing direct instant messaging (IM) communication between wireless devices (whereby an IM session is initiated on a client/server paradigm and responsive to identifying at least one additional wireless device belonging to a same piconet, the IM session is transformed into a peer-to-peer communication by establishing a direct instant messaging connection between wireless devices). However, such art remains inextricably tied to peer-to-peer communications, whereas our art may be directed at peer-to-peer, peer-to-many, many-to-many communications, as well as the coupling of location and presence/availability information, SMS/USSD/MMS integration (among others), together with an innovative ‘single stroke’ PTT initiation mechanism. Furthermore, with the application by Betzler, the communications appear to be limited within the geographic scope of the same ‘Piconet’ (our invention of present facilitates communications between wireless devices on a macroscopic basis (including different networks (e.g. GPRS (cellular) versus WLAN hotspots)). U.S. patent application 20030126213.by Betzler also appears to be limited to communications between two (2) wireless devices on the same ‘Piconet’—that is there is no means of initiating communications among several (more than two (2)) wireless devices.

U.S. patent application 20020035605 by McDowell et al., entitled use of presence and location information concerning wireless subscribers for instant messaging and mobile commerce, generally provides art aimed at integrating elements of presence and location (determination), instant messaging and m-commerce into a wireless provider's network. However, the art remains constrained in not providing or intimating elements relating to voice, and PTT mechanism and related art.

UK Patent Application 2380633 entitled, allowing GSTN/PSTN subscribers access to internet, instant messaging and presence/multimedia services, remains focused upon and tied to integrating legacy devices. In particular, the application requires the use of a ‘gateway’ platform in order to provide for a form of instant messaging service. Our invention of present leverages the considerable computational power inherent in contemporary wireless devices (including mobile phones and mobile computational devices including laptops and personal digital assistants), and in particular, permits such wireless devices to connect to an instant messaging server using IP based communication protocols as opposed to circuit switched protocols as disclosed in UK Patent Application 2380633.

### REFERENCES CITED

| | | | |
|---|---|---|---|
| U.S. Patent Application | | | |
| 20030126213 | July, 2003 | Betzler, B. | 709/206 |
| 20030014488 | January, 2003 | Dalal et al. | 709/204 |
| 20020035605 | March, 2002 | McDowell et al. | 709/206 |
| Foreign Patent Documents | | | |

| | | |
|---|---|---|
| 2380633 | April, 2003 | GB |

### TECHNICAL FIELD

The present invention relates generally to telecommunications network implementations for facilitating wireless messaging and conferencing; and in particular to a wireless instant messaging and multi-media conferencing solution.

### SUMMARY OF THE INVENTION

Disclosed is a wireless instant messaging and multi-media conferencing solution, which may at the outset be functionally divided among a first computer program product (CPP1) which is articulated within wireless handsets and/or similar devices capable of supporting such art, thereby enabling the receipt, manipulation, transmission and even storage (locally) of text, images, voice, and audio. (As Symbian represents one of larger, more widespread open, standard operating system (OS) initiatives for mobile phones, the art has been articulated principally against such platforms, largely owing to the support of ‘soft buttons’ wherewith one or more buttons may be assigned specific functions, however, practitioners may well appreciate that functionally equivalent ‘Symbian-like’ platforms may well be substituted as the art evolves or becomes known).

As well as a multi-cast server or like network element intended to provide similar functionality imbibed with a further second computer program product (CPP2) encompassing like logical instructions, algorithms and advances to the art which enables real-time simultaneous multi-media communication(including client-based multicasting) between suitably equipped wireless handsets and/or devices (loaded locally with the aforementioned computer program product (CPP1)). Said CPP2, in utilizing the existing bearer capabilities of GPRS networks, provides multi-cast server functionality for real-time distribution of content (text messages, pictures, media (e.g. voice)) between registered and authenticated clients of the solution.

In other embodiments, integration with MSN's proprietary Messenger enriches the overall subscriber experience via a presence capability and extends connectivity to non CPP1 enabled devices. Additionally, the invention promotes existing legacy devices through SMS messaging support for distribution of Instant Messages between designated groups/peers. In further alternate embodiments, there remains support for Wireless Village IMPS specification to facilitate inter-carrier IMPS services.

To connect to CPP2, the user will need to enter connection information such as the IP address of the server, port, username, password (among others in varying embodiments). Upon initiating CPP1, the application connects to CPP2 using well-known programmatic and telecommunications authentication and like means, and the client ‘Contact List’ is populated with the list of on-line contacts (in the preferred embodiment). CPP2 also sends updates to other connected clients (which have CPP1 articulated within their handsets) to inform them of the new connection. A status icon within the client displays the current online/offline status of the user.

The invention (CPP1 and CPP2) supports multiple simultaneous chat conversations on a single client instance. The multiple conversation windows are navigable via a tabbed user interface. One conversation window is opened for each conversation in which the user is participating and each conversation independently maintains a browsable message history. In addition to receiving voice messages, the client software (CPP1) allows users to initiate new conversations with both voice and text messages. A single instantiation of CPP1 is required to access all the functionality of CPP2 and the solution in general.

### BRIEF DESCRIPTION OF THE DRAWINGS

FIG. 1 illustrates a typical, non-limiting embodiment of the system level architecture employed in the disclosure of present.

### DETAILED DESCRIPTION OF THE PREFERRED EMBODIMENTS

Members skilled in the art will recognize that the ensuing represents an illustrative recital of the preferred embodiments of the invention of present and other embodiments may be articulated, gleaned and articulated from such while still remaining with in its spirit and scope. Indeed, equivalents found within the state of the art, and those which may reasonably and effectively be deemed equivalent in the future should also be understood as being incorporated by reference hereto and such. Furthermore, much of the language has been illustrative and is to be construed as expressly for pedagogical purposes in helping elucidate the art as concisely and beneficially as practical.

For simplicity and ease of instruction practitioners will recognize the totality of the wireless instant messaging and multi-media conferencing solution consists of certain discrete elements of which CPP1, and CPP2 form elements, but only when combined with other telecommunications and/or network elements does the full potency of the invention become apparent.

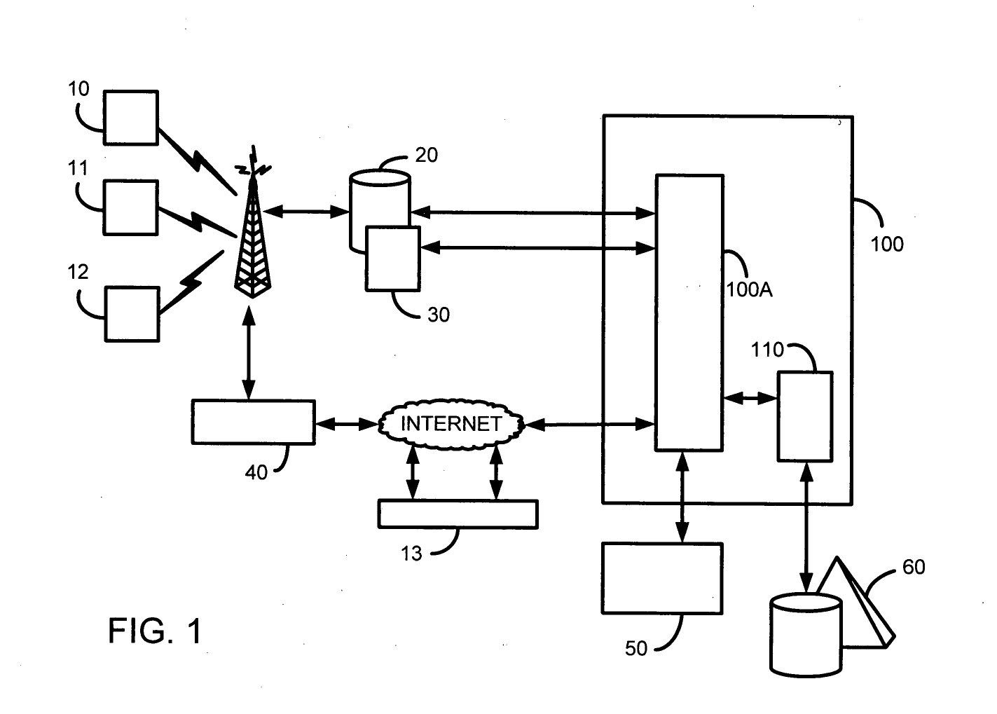

With reference now to FIG. 1, which demonstrates the multi-cast functionality 100A as it relates to certain elements of the invention articulated as part of a computer program product (CPP2) 100. Certain elements of the invention which are articulated as part of a computer program product (CPP2) 100, are imbibed with multi-cast server functionality 100A, which permit Symbian-based clients in compliant handsets 10, 11 to enable real-time simultaneous multi-media communications with peers or group members. Practitioners skilled in the art may well appreciate that functionally equivalent ‘Symbian-like’ platforms may well be substituted as the art evolves or becomes known, without diluting the intent and scope of the totality of the invention disclosed herewith. Said multi-cast server functionality 100A enables instant and chat-based multi-media communication between suitably equipped handsets 10, 11 and provides for the distribution of content (voice messages, text messages, pictures, video) between registered and authenticated clients. Such clients may establish sessions using techniques well-known and documented in the state of the art.

Said client device 10, 11, has been pre-loaded with an application (CPP1) for accessing the multi-cast server functionality 100A through Messaging API to initiate/respond to messaging sessions. Technicians skilled in the art will also recognize that any number of protocols, triggers and interfaces may be employed herewith, and indeed, remain only bound by the state of the art and the reference to any one protocol (or similar rules, methods and means for the transmission of data) remains purely for the purposes of simplicity and ease of instruction, and do not serve to dilute the application and scope of the invention as such.

Thus, with respect to this embodiment of the invention as it relates to multi-cast server functionality 100A, a mobile user 10 (in this instance) may log onto a telecommunication carrier's data network (and the network will therewith authenticate and authorize user for Internet usage). Said user 10 logs into the multi-cast server functionality 100A of the invention 100, upon which, said functionality will authorize and authenticate the user, and update the internal user database (not shown but logically incorporated into 100). Users 11, 12 (in this instance), will already have user 10 on their contact list and thus, a user update message will be sent to them. Said user 10 sends a voice, text or other multi-media message to the other users 11, 12. The multi-cast server functionality of the invention 100, accepts message and initiates multicast stream to destination users. Upon receiving the message from 10, the recipients 11, 12 reply through any number of multi-media means. And so forth. Where a user 10 decides to leave chat session, and logoff, messages are sent to multi-cast server functionality of the invention (CPP2) 100 and updates are accordingly passed to other users 11, 12.

To satisfy billing concerns and needs, certain elements of the invention articulated as part of a computer program product 100 may interface, with credit bureaus (and other external billing (or voucher) systems) 50. The invention 100, may in alternate embodiments, be juxtaposed and co-articulated with an Open Charging (OC) middleware platform and gateway system 110 as detailed in patent application Ser. No. 10/307335, for mediation with a prepaid or postpaid platform 60 (for account decrement, balance inquiry and other similar purposes). Noble technicians skilled in the art will recognize that the invention of present need not be limited to the aforementioned Open Charging (OC) middleware platform and gateway system and other similar network implementations may be employed without diluting the intent and scope as such.

The wireless instant messaging and multi-media conferencing solution supports ‘walkie-talkie’ style communication capabilities over existing GPRS/1XRTT networks. As before, where said client software 10, 11, 12 (CPP1) runs on Symbian 6.x and 7.x operating system and next-generation handsets. Practitioners skilled in the art may well appreciate that functionally equivalent ‘Symbian-like’ platforms may well be substituted as the art evolves or becomes known, without diluting the intent and scope of the totality of the invention disclosed herewith. Indeed, in its most rudimentary state, the ‘push to talk’ (PTOT) system allows one-to-one and one-to-many chat sessions. For example, a user 10 is able to send voice messages to one person 11, or a group of people 11, 12 simply by pressing and holding a button. The message is then streamed to CPP2 100 before being ‘pushed’ to all conversation participants 11, 12 (and even 13 if suitably equipped). In this basic mode of operation (in alternate embodiments), upon receipt of the message, the client plays a signaling beep followed by the message in its entirety. In the preferred embodiment, a PTOT event is stored in the client conversation history window.

In alternate embodiments, the PTOT aspects of the art, will remain configurable in that it may optionally operate in an ‘invite mode’ and ‘floor control mode’ consistent with the Push-To-Talk over Cellular (PoC) specifications, where the terminating parties are paged and explicitly indicate whether they will receive any subsequent communications from the originator (once they accept a page, they can automatically communicate back to the originator assuming that they are granted control of the floor). (Indeed, in advancing the art, said ‘floor control mode’ is invoked to avoid ‘collisions’ of simultaneous one-to-many conversations).

1. A system for implementing a wireless instant messaging and multi-media conferencing solution.

2. The system of claim 1, which includes a first computer program product (CPP1), comprising:
a) a computer readable memory medium; and
b) a computer program including the logic required to the steps, methods and rules as such.

3. The system of claim 2, where said first computer program product remains articulated within wireless handsets and/or similar devices.

4. The system of claim 3, where said first computer program product is implemented on any operating system (OS) for wireless handsets and/or similar devices which supports the implementation of ‘soft’ buttons.

5. The system of claim 2, which enables the receipt, manipulation, transmission and local storage of text, images, voice, and audio.

6. The system of claim 1, which includes a second computer program product (CPP2), comprising:
a) a computer readable memory medium; and
b) a computer program including the logic required to the steps, methods and rules as such.

7. The system of claim 6, where said second computer program product remains articulated within the telecommunications operator's (or like entity's) network.

8. The system of claim 7, where said second computer program product has been articulated to provide multi-cast server functionality, thereby enabling real-time simultaneous multi-media communication between suitably equipped wireless handsets or devices (CPP1) together with the functionality for real-time distribution of multi-media content.

9. The method of claim 7, where said second computer program product may also be integrated with proprietary computer based Messaging systems (as MSN Messenger) via a presence capability thereby extending connectivity to non-CPP1 enabled devices.

10. The method of claim 7, which also promotes existing legacy devices through SMS messaging support for distribution of Instant Messages between designated groups/peers.

11. The method of claim 10, which supports Wireless Village IMPS specifications to facilitate inter-carrier IMPS services.

12. The methods of claims 2 and 6, which connect to one another using well-known programmatic and telecommunications authentication and like means.

13. The method of claim 12, which is achieved upon initiation of the first computer program product (CPP1).

14. The method of claim 12, where a client list or list of ‘contacts’ is populated.

15. The method of claim 14, where said contacts are on-line (connected to the communications network).

16. The method of claim 14, where said contacts may also be in an off-line stated (including hibernation or inaccessible roaming situation).

17. The method of claim 14, where the status of such contacts may be displayed and/or represented through any number of symbols or iconographic means.

18. The method of claim 14, where such population my take place through aural, or other sensory means (as vibrating pulses for the impaired), in addition to the usual visual means.

19. The method of 12, where other on-line contacts are updated by the second computer program product as to the new connection.

20. The method of claim 19, where such updates may occur through aural, or other sensory means (as vibrating pulses for the impaired), in addition to the usual visual means.

21. The method of claim 14, where multiple conversation windows (text or audio) may be opened, and navigated through graphical user interface (GUI).

22. The method of claim 21, where such conversations may be stored as SMS, MMS, voice mails and other such wireless communication methodologies for users who are in an off-line state, or on-line but who may wish to locally store such content.

23. A method for initiating wireless instant messaging and multi-media conferencing by holding and pressing an articulated button (‘hard’ or ‘soft’ buttons may equally be employed) on the wireless device in question, wherewith the message (audio, visual, or vibrational) from CPP1 is pushed by CPP2 to all conversation participants, or only those on-line and/or available.

24. The method of claim 23, where such one-touch Push TO Talk (PTOT) wireless instant messaging and multi-media conferencing may be stored locally on the recipient's device and/or preceded by warning tones and/or assigned priority accordingly.

25. The method of claim 23, where, consistent with the Push-To-Talk over Cellular (PoC) specifications, the receiving or terminating parties are paged and explicitly indicate whether they will receive any subsequent communications from the originator (once they accept a page, they can automatically communicate back to the originator assuming that they are granted control of the floor).

26. The method of claim 25, which alleviates ‘collisions’ of simultaneous one-to-many conversations.
